(19) United States
(12) Patent Application Publication
(10) Pub. No.: US 2015/0295447 A1
(43) Pub. Date: Oct. 15, 2015

(54) ENERGY STORAGE FOR FURNITURE AS WELL AS FURNITURE WITH ENERGY STORAGE

(71) Applicant: Nitz Engineering GmbH, Brixen (IT)

(72) Inventor: Rüdiger Nitz, Feldthurns (BZ) (IT)

(21) Appl. No.: 14/682,447

(22) Filed: Apr. 9, 2015

(30) Foreign Application Priority Data
Apr. 9, 2014 (DE) 20 2014 101 674.0

(51) Int. Cl. H02J 7/00; H02J 7/02

(52) U.S. Cl. CPC H02J 7/0054; H02J 7/0047; H02J 7/025; H02J 7/0042; H02J 2007/005

(57) ABSTRACT

A piece of furniture is provided, in particular, a table, a high table, or desk, wherein a storage module for storing electrical energy and for supplying the stored electrical energy to an electrical device to be disposed at or in the piece of furniture can be arranged at or in the piece of furniture. The storage module preferably can be arranged within a closable/lockable recess. Preferably, the storage module can be coupled to transmission means, which are adapted to transmit electrical energy supplied from the storage module to the electrical device to be disposed at the piece of furniture. The transmission means preferably comprise an inductive charging system. Further, a corresponding storage module for a piece of furniture as well as a furniture system are provided comprising a piece of furniture according to the invention and at least one storage module according to the invention are provided.

### CROSS REFERENCE TO RELATED APPLICATIONS

This application claims priority under 35 U.S.C. §119 to German Application No. 20 2014 101 674.0, filed Apr. 9, 2014, the contents of which are incorporated by reference herein.

### FIELD OF THE INVENTION

The invention relates to a storage module or energy storage for a piece of furniture, by means which electrical devices arranged at or on the piece of furniture, such as smartphones, can be charged, as well as to a piece of furniture adapted for this. Further, the invention relates to a furniture system with a piece of furniture according to the invention and a storage module according to the invention.

### BACKGROUND OF THE INVENTION AND PRIOR ART

In prior art, furniture is known into which components of a charging device are integrated, which allow for charging of an electrical device, such as a smartphone, which has been deposited on the piece of furniture.

Such pieces of furniture are, for example, known from DE 20 2012 101 236 U1, or from DE 20 2012 104 775 U1. There, a recess is provided at the bottom of the furniture panel, in which components of an inductive charging system may be arranged, in order to charge an electrical device inductively which has been deposited on the furniture panel.

With this, however, it is disadvantageous that these inductive charging systems have to be supplied with electrical energy in order to be operated themselves, and, on the other hand, in order to provide electrical energy for the inductive energy transmission. With respect to the latter it is known to connect the inductive charging systems integrated into the furniture panel by means of an electrical cable to an external power supply, as a wall socket.

However, in this case it is disadvantageous that the inductive charging system integrated into the piece of furniture can only be used, if such an external power supply is available, and the connection cable has the appropriate length. A further disadvantage is that such cables for power supply of the inductive charging system constitute a certain obstacle (e.g., a tripping hazard).

Further, the provision of such cables for the power supply of the inductive charging systems in many cases is not possible, for example, with respect to high tables in a pub or in a bar, because for each table, a corresponding cable has to be provided for the power supply. It may be conceivable that for such high tables, power sockets embedded into the floor are provided, into which the respective cables can be inserted. This, however, in turn has the disadvantage that the high tables to a large extent have to be placed there, where the sockets embedded into the floor are arranged such that a substantially flexible arrangement of the high tables is almost impossible.

Therefore, it is an object of the invention to provide solutions, which allow for a more flexible application of a piece of furniture having an inductive charging system integrated therein and which to a large extent are independent of external power supply means.

### SUMMARY

This object is solved according to the invention by a piece of furniture, in particular, a table, a high table, or a desk, by a storage module for the piece of furniture according to the invention, as well as by a furniture system according to the independent claims. Preferred embodiments and further developments of the invention are specified in the respective dependent claims.

Accordingly, a piece of furniture is provided, in particular, a table, a high table, or a desk, whereby a storage module for storing electrical energy and for supplying the stored electrical energy to an electrical device which may be arranged at the piece of furniture can be arranged at or in the piece of furniture.

Thereby, it is advantageously avoided that modules for charging an electrical device deposited on the piece of furniture which are integrated into the piece of furniture have to be connected to an external power supply, for example, via a cable to the sockets. The piece of furniture may be placed independently of the external power supply units, allowing for a more flexible use of the piece of furniture.

According to a preferred embodiment, the piece of furniture has a recess or a through hole, in which the storage module can be arranged. Preferably, the storage module can be arranged in the recess or in the through hole releasably. Thereby, it is advantageously enabled, for example, to change the storage module, and to replace it by a new or charged storage module. Moreover, by this it can be avoided that the piece of furniture for charging the storage module has to be connected to an external power supply.

In or at the piece of furniture transmission means may be arranged or are arranged, which are adapted to transmit the electrical energy supplied from the storage module to the electrical device which can be arranged at the piece of furniture.

The transmission means may comprise a transmitter of an inductive charging system, or a terminal for a charging cable of the electrical device.

Preferably, electrical wires are arranged in the piece of furniture, which electrically contact the storage module to the transmission means.

In the recess or in the through hole of the piece of furniture, connection contacts may be arranged or provided, which correspond to connection contacts of the storage module and which cooperate with the latter, when the storage module is arranged in the recess or in the through hole. Thereby, a particularly simple replacement of the storage module is enabled.

The connection contacts which are arranged in the recess or in the through hole may be coupled to the electrical wires.

According to a preferred embodiment of the invention, the recess or at least one side of the through hole may be covered by a cover plate and/or may be closable or lockable. The cover plate, hereby, may be a part of the storage module.

The cover plate may further comprise fixing means, by means of which the cover plate may be fixed at the piece of furniture, in particular, at or in the recess or in the through hole. Preferably, the fixing means comprise locking means, in particular, a lock. Thereby, the cover plate may be blocked such that an unauthorized removal of the storage module may be counteracted effectively.

According to an embodiment of the invention, connection means for connecting the piece of furniture to an external power supply may be provided at the piece of furniture. This is, in particular, with respect to stationary furniture, as bookshelves, counter tops, or the like, which do not have to be adapted to be flexibly arranged in space, advantageous.

The connection means may be connected electrically to the storage module, if the storage module is arranged within the recess or within the through hole. Thereby, the storage module can be charged, which is particularly advantageous in such a case, where the storage module is fixedly integrated in the piece of furniture, i.e., it cannot be released from the piece of furniture.

Moreover, a storage module for a piece of furniture, in particular, for a piece of furniture according to the invention is provided by the invention, wherein the storage module is adapted for storing electrical energy and for supplying the stored electrical energy to a terminal device, and which may be arranged at or on the piece of furniture, wherein the storage module can be integrated into the piece of furniture and can be coupled electrically to transmission means arranged in or at the piece of furniture, which transmission means are adapted to transmit the electrical energy supplied from the storage module to the electrical device arranged at or on the piece of furniture.

The storage module may be coupled electrically to the transmission means via electrical wires arranged in the piece of furniture.

According to an embodiment of the invention, the storage module may be coupled electrically to the transmission means on an inductive basis. Hereby, it is advantageous, if the storage module has at least a transmitter coil, via which electrical energy of the storage module is transmitted to the transmission means.

It is advantageous, if the cover plate is arranged at the storage module.

The cover plate may be adapted with respect to its dimension so as to close or cover the recess or at least a side of the through hole when arranging the storage module within a recess or within a through hole of the piece of furniture.

The cover plate may comprise fixing means, by means of which the cover plate may be fixed at the piece of furniture, in particular, at or in the recess or at or in the through hole.

The fixing means may comprise locking means, in particular a lock, by means of which the cover plate may be locked.

According to an embodiment of the invention, the cover plate may be arranged at a housing of the storage module.

It is advantageous, if the storage module can be connected to an external charging means in order to charge the storage module.

According to an embodiment of the invention, the storage module may comprise an internal charging means, which can be connected to an external power supply in order to charge the storage module.

The storage module may comprise connection contacts, which correspond to connection contacts arranged within the recess or within the through hole of the piece of furniture, and which cooperate with the latter, when the storage module is arranged within the recess or within the through hole, whereby the connection contacts preferably are coupled to transmission means electrically, which are arranged in or at the piece of furniture.

The storage module may comprise indication means, which are adapted to indicate a charging state of the storage module. Thereby, for the storage module integrated in the piece of furniture, it is possible to determine from the outside, which charging state the storage module has without having to remove or dismantle the storage module.

According to an embodiment of the invention, the indication means may be arranged at the cover plate, and may preferably comprise a light emitting diode.

According to an embodiment of the invention, the storage module may comprise a number of storage means being connected to each other in series and/or in parallel, in particular, accumulators, which preferably are arranged within a housing.

It is preferred, if venting holes and/or venting slots are provided in the cover plate, in particular, to dissipate heat energy of the storage module.

Further, an electrical component for inductive transmission of electrical energy to an electrical device which may be arranged relative to the electrical component is provided by the invention, in particular, for charging an energy storage of the electrical device, wherein the electrical component comprises a transmitter of an inductive charging means and a storage module, wherein the storage module is adapted to store electrical energy and to supply the stored electrical energy to the transmitter.

It is advantageous, if the storage module may be arranged at the transmitter releasably.

The transmitter may comprise a transmitter coil, wherein the transmitter coil is arranged at a top side, which during charging of the electrical device faces the electrical device of the housing of the electrical component, and wherein the storage module is arranged at a bottom side of the housing.

It is advantageous, if the top side of the housing comprises a stable and at least partially non-metallic material.

A cover plate may be arranged at the top side of the housing.

The cover plate may at least partially protrude beyond the outer circumference of the housing.

The electrical component may comprise connection means for connecting the storage module to an external power supply or to a charging device for charging the storage module.

The electrical component may at least partially be arranged within a recess or within a through hole of a furniture panel of a piece of furniture, preferably, may be arranged releasably.

Further, the furniture system is provided by the invention comprising a piece of furniture, in particular, a piece of furniture according to the invention, and at least the storage module or an electrical component, in particular, the storage module according to the invention or an electrical component according to the invention, wherein the at least one storage module or the at least one electrical component may be integrated into the piece of furniture.

According to an embodiment of the furniture system according to the invention, the storage module may be arranged within the recess or within the through hole of the piece of furniture releasably.

According to an alternative embodiment of the furniture system according to the invention, the storage module may be integrated into the piece of furniture non-releasably, wherein the piece of furniture comprises connection means in order to connect the storage module for charging at an external power supply.

### BRIEF DESCRIPTION OF THE DRAWINGS

Details and features of the invention as well as concrete embodiments of the invention can be derived from the following description in connection with the drawing in which:

FIG. 1 shows a piece of furniture according to the invention with a storage module according to the invention in a side view and in two perspective views;

FIG. 2 shows a storage module according to the invention in a side view and in a perspective view;

FIG. 3 shows a sectional view of the piece of furniture according to the invention having a storage module according to the invention integrated therein;

FIG. 4 shows a sectional view of a further piece of furniture according to the invention with the storage module according to the invention integrated therein or arranged at the piece of furniture;

FIG. 5 shows a storage module according to the invention arranged at a furniture panel, which provides electrical energy necessary for charging of electrical devices on an inductive basis to a transmission means;

FIG. 6 shows embodiments of electrical components according to the invention.

### DETAILED DESCRIPTION OF THE PREFERRED EMBODIMENTS

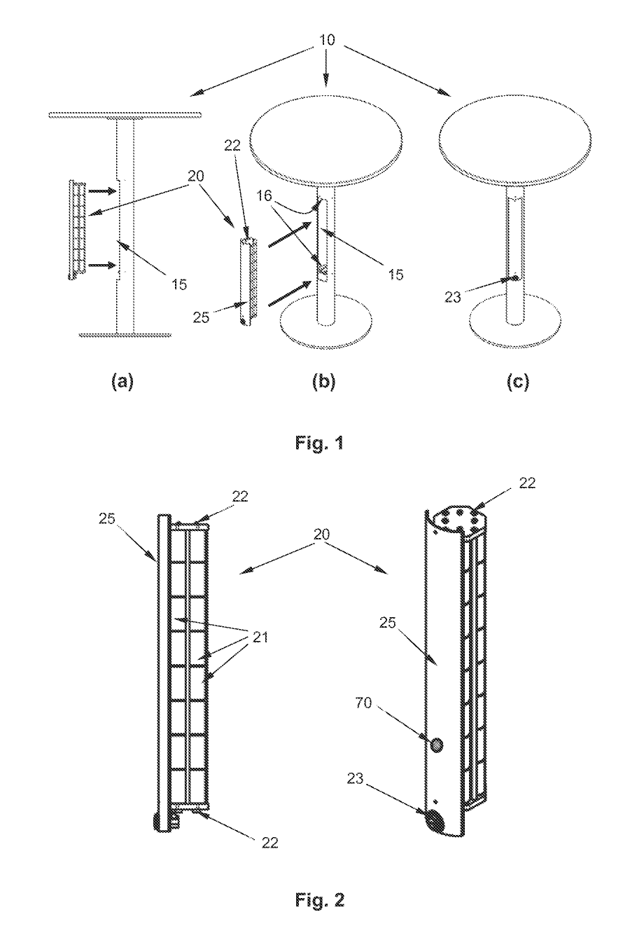

FIG. 1 shows the piece of furniture according to the invention and the storage module according to the invention in a side view (a) and in two perspective views (b) and (c).

The piece of furniture 10 according to the invention in the embodiment shown in FIG. 1 is a high table, as used for example in bars or pubs. The high table has a table leg, at the upper end of which a table top and at the lower end of which a table base is arranged.

The table leg has a certain diameter such that sufficient space is provided in order to arrange the storage module 20 according to the invention within the table leg. The table leg in the embodiment shown in FIG. 1 has an elongated recess 15, which forms the accommodation space for accommodating the storage module 20 according to the invention.

According to the invention, the recess 15 and the storage module 20 are configured such that for the implementation, the storage module 20 only has to be inserted into the recess 15. For this, connection contacts 16 are provided in the recess 15, which correspond to the connection contacts 22 of the storage module 20 and cooperate with these, when the storage module 20 is arranged within the recess 15. Thereby, a tool free mounting or de-mounting of the storage module 20 according to the invention is possible.

The storage module 20 according to the invention has a cover plate 25, by means of which the recess 15 is covered to a large extent after the insertion of the storage module 20 into the recess 15. Preferably, the cover plate 15 is configured such that the initial surface of the table leg is reestablished, as can be seen in figure (c), which shows a piece of furniture with an integrated storage module.

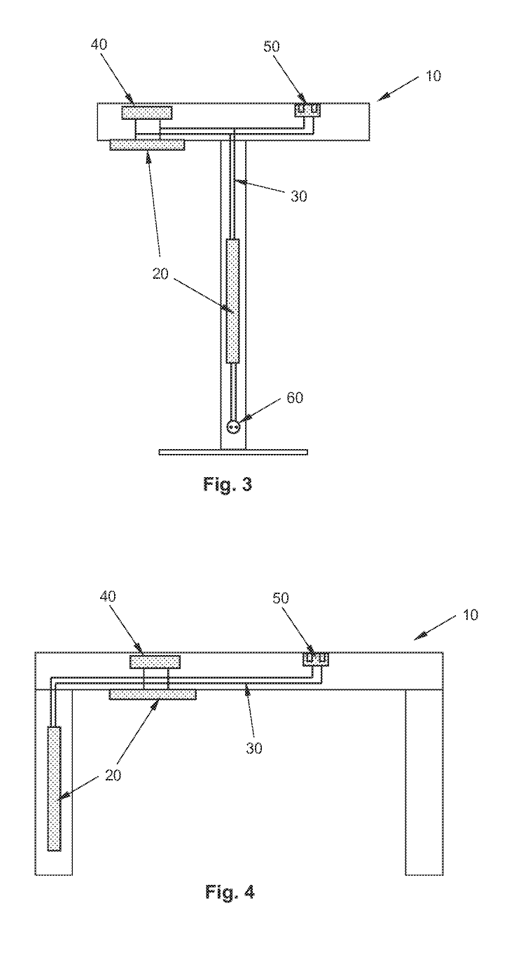

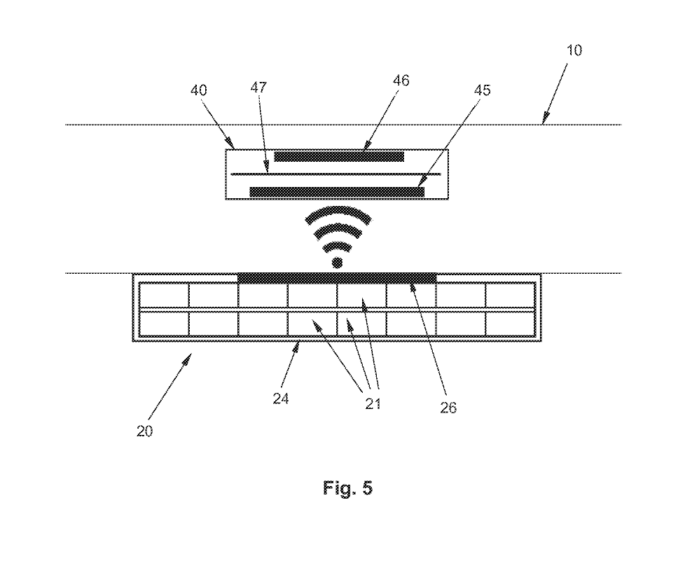

After the storage module 20 according to the invention has been integrated into the table leg 15, the storage module is able to supply electrical energy for charging an electrical device deposited on the table. An embodiment of a table, which is adapted to charge electrical devices deposited on the table will be further described with reference to FIG. 3, FIG. 4, and FIG. 5.

An advantage of the piece of furniture 10 according to the invention with an integrated or integratable storage module 20 is that electrical devices arranged at or on the piece of furniture 10 can be charged without an external power supply being necessary for this are without having to connect the piece of furniture or the charging means in the piece of furniture to an external power supply for this. Thereby, the flexibility of the piece of furniture is substantially increased, for example, with respect to the arrangement of the piece of furniture within a room. This is because the piece of furniture according to the invention can be arranged or set up within the room regardless of any external power supply units, for example, sockets.

In FIG. 2, a high table is shown as the piece of furniture according to the invention. According to the invention, the storage module 20 according to the invention may be integrated into any arbitrary piece of furniture, for example, bookshelves, worktops, or other furniture, on which electrical devices may be deposited. For example, an implementation would be the integration of storage modules according to the invention into dining tables of a fast food restaurant, wherein the dining tables are adapted to charge up on the position of an electrical device the latter wirelessly, for example, by means of an inductive charging means, as has been described, for example, in the initially mentioned prior art.

FIG. 2 shows the storage module 20 according to the invention in a side view and in a perspective view.

The storage module 20 consists of a number of storage means, for example, accumulators 21, which are connected to each other serially and/or in parallel. The storage means 21 may be arranged within the housing not shown here.

The storage module has at the upper end and at the lower end connection contacts 22, which correspond to the connection contacts 16 within the recess 15 of the piece of furniture 10, when the storage module 20 is arranged within the recess 15. Thereby, a time consuming connection of the storage module, for example by means of plug contacts, is avoided, allowing for a simple and efficient mounting and de-mounting of the storage module. The storage module 20 may simply be inserted into the recess 15.

The storage module 20 has a cover plate 25, which is adapted to cover or close the recess 15 of the piece of furniture 10. Thereby, the cover plate 25 preferably is configured such that the latter reestablishes the initial surface of the piece of furniture in the region of the recess 15 such that after inserting the storage module 20 into the recess 15 of the piece of furniture 10, the aesthetic or overall impression of the piece of furniture 10 is not affected disadvantageously. Preferably, the cover plate 25 may be produced from the same material as the area of the piece of furniture which has the recess 15.

In an embodiment not shown here, the cover plate 25 may have a number of borings or slots, which serve as ventilation holes or ventilation slots. Thereby, during operation of the storage module, excessive heat energy can be dissipated in order to prevent an overheating of the storage module arranged within the recess 15.

In a particular embodiment of the storage module 20 according to the invention, indication means 17 may be arranged at the cover plate 25, by means of which the charging state of the storage module can be indicated. For example, as indication means, a light emitting diode (LED) can be used. According to an embodiment, the light emitting diodes may flash, if the capacity of the storage module falls below a predetermined threshold value, what may be detected by suitable electronics in the storage module 20. According to an embodiment, the light emitting diode may flash in green color, if the capacity of the storage module lies above a predetermined threshold value, and may, for example, flash in red color, if the capacity falls below the predetermined threshold value. Thereby, it may be determined from the outside in a simple manner, whether a changing or a charging of the storage module 20 is necessary. In case the capacity of the storage module falls below the predetermined threshold value, the storage module 20 may be replaced particularly simply by another or a new storage module. The storage module 20 which has been removed, may then be charged again by a suitable charging means.

A charging means for charging as storage module according to the invention preferably is configured such that the storage module according to the invention only has to be put into the storage means, as soon as the storage module 20 is inserted into the recess 15 of the piece of furniture 10.

According to an alternative embodiment of the invention, the storage module 20 may comprise an integrated charging means or charging electronics provided for charging the storage module such that the storage module 20 only has to be connected to an external power supply, as a socket. For this, the storage module may comprise a corresponding plug-in location, into which a charging cable may be plugged in.

According to the embodiment of the storage module 20 shown in FIG. 2, a fixing means 23 is arranged at the cover plate 25, by means of which the storage module inserted into the recess 15 may be fixed at the piece of furniture. Preferably, the fixing means 23 may be configured as a lock in order to prevent an unauthorized removal or demounting of the storage module 20 from the piece of furniture.

FIG. 3 shows a piece of furniture 10 according to the invention in cross section. The piece of furniture according to the invention, here, is configured as a high table 10.

In the embodiment shown in FIG. 3, the storage module 20 according to the invention is integrated in the table leg of the high table 10, which is connected electrically via electrical wires 32 transmission means 40, 50. The transmission means 40, 50 comprise a transmitter 40 of an inductive charging means and a terminal for a charging cable of an electrical device.

The transmitter 40 of the inductive charging means in the embodiment shown here is completely integrated into the tabletop of the high table 10, i.e., it is not visible from the outside. According to an alternative embodiment, the transmitter 40 may be integrated into the tabletop of the high table 10, and may be covered at the top side of the tabletop by a cover plate.

The terminal 50 of a charging cable of an electrical device may comprise a common socket or a USB interface or a micro USB interface. Alternatively, also proprietary terminals may be provided.

By depositing an electrical device, for example, a smart phone having a receiver of an inductive charging means, on the surface of the tabletop in the area of the transmitter 40, the electrical device can be charged inductively. Should the electrical device have no receiver of an inductive charging means, the electrical device can be charged by means of a corresponding charging cable at the terminal 50. The electrical energy needed for the charging of electrical devices is provided by the storage module 20 integrated in the piece of furniture.

According to an alternative embodiment of the invention, the storage module 20 may also be arranged at a surface of the piece of furniture 10, for example, at the lower side of the tabletop of the piece of furniture 10. In this case, the storage module 20 according to the invention is also connected to the transmission means 40, 50 electrically via electrical wires 30. The storage module 20 arranged at the surface of the piece of furniture 10, may, for example, be connected releasably by means of clips or other fixing means which allow for a tool-free fixation of the storage module at the piece of furniture. Alternatively, screw connections may be provided in order to fix the storage module 20 at the piece of furniture.

It is, however, preferable, if the storage module 20 is integrated or integratable in the piece of furniture 10 such that the storage module is not visible from the outside, and the piece of furniture 10 has or maintains its initial shape or surface. This is achieved by arranging the storage module 20 according to the invention in a recess 15 of the piece of furniture 10 and the storage module 20 having a cover plate 25, which basically reestablishes the surface of the piece of furniture in the area of the recess and which covers the recess.

A further advantage of the integration of the storage module into the piece of furniture 10 is that the storage module is protected efficiently from external influences, as external forceful impacts. Further, by the integration of the storage module into the piece of furniture, stealing of the storage module may be counteracted efficiently.

According to an embodiment of the invention, a connection means 60, for example a socket, may be provided at the piece of furniture 10, which is connected electrically to the storage module 20 according to the invention via electrical wires. The socket 60 may, for example, be provided in order to connect the storage module 20 integrated into the piece of furniture 10 to an external power supply, and to charge the storage module 20. This is, in particular, advantageous in the case, when the storage module 20 is integrated into the piece of furniture when such that it may not be removed from the piece of furniture. The storage module 20, hereby, has electronics required for the charging of the storage module 20. By this, the piece of furniture 10 can be connected to an external power supply via the socket 20 in order to charge the storage module. After completion of the charging procedure, the piece of furniture may be disconnected again from the external power supply. Thereby, the piece of furniture according to the invention can be used intentionally after the charging of the storage module without guiding the disturbing electrical cable away from the piece of furniture.

FIG. 4 shows an alternative is of furniture 10 according to the invention.

With respect to the piece of furniture shown in FIG. 4, a desk 10 is concerned, which has two or more table legs. The storage module 20 according to the invention is integrated in one table leg. Also here, the storage module 20 may be integrated into the table leg releasably, or may be integrated in the table leg such that it cannot be removed from the piece of furniture 10. According to the variant which is not removable, it is in turn advantageous, if a connection means, for example a socket 60, is arranged within the piece of furniture 10, which is coupled electrically to the charging module 20.

Also with respect to the piece of furniture according to the invention shown in FIG. 4, the storage module 20 may be fixed in an alternative embodiment at a lower side of the top plate, as explained with reference to FIG. 3.

The storage module 20 is connected electrically to transmission means 40, 50 via electrical cables 30 integrated in the piece of furniture 10, wherein also with respect to the embodiment shown in FIG. 4, the transmission means comprise a transmitter 40 of an inductive charging means and a terminal for the charging cable off an electrical device.

FIG. 5 shows the storage module 20 according to the invention, which is arranged at the lower side of the furniture panel 10. Alternatively, the charging module 20 may also be arranged in a recess at the lower side of the furniture panel of the piece of furniture 10.

The storage module 20 has a housing 24, in which the storage means 21 are arranged. Further, a primary coil or transmitter coil of an inductive charging means is arranged within the housing 24, which is directed to the side of transmission means 40 integrated in the furniture panel. In the area of the transmitter coil 26, the housing 24 comprises a material, which enables an inductive energy transmission between the storage module 20 and the transmission means 40.

The transmission means may comprise a secondary coil or receiver coil 45, which cooperates with the transmitter coil 26 of the storage module 20 via an inductive energy transmission which is carried out between the storage module 20 and the transmission means 40. Further, the transmission means 40 may comprise a primary coil or transmitter coil 46, via which an energy transmission is carried out between the transmission means 40 and an electrical device deposited on the topside of the furniture on an inductive basis, as far as the electrical device is adapted for an inductive energy transmission. Between the transmitter coil 46 of the transmission means and the receiver coil 45 of the transmission means 40 preferably there is arranged the shielding 47, which shields the two coils against each other.

With respect to a solution according to which the storage module according to the invention is coupled to the transmission means via electrical wires, the solution shown in FIG. 5 has the disadvantage that the entire coefficient of performance may be lower. The solution according to FIG. 5 has, however, the advantage that as far as the transmission means comprise a receiver coil 45, an ad hoc power supply of the transmission means 40 is possible, for example, if the storage module integrated into the piece of furniture and being coupled to the transmission means 40 via electrical wires fails due to a defect and no replacement storage module is available, which can be integrated into the piece of furniture for replacement.

The storage module 20 shown in FIG. 5, which enables an inductive energy transmission, hereby has the substantial advantage that this storage module is independent of any electrical connections and may be arranged independently of the size of any recesses in the piece of furniture 10, wherein the only thing that has to be taken care off is that the storage module is able to be fixed to the piece of furniture. In a simple embodiment, a number of suction cups may be provided at the housing, by means of which the storage module can be fixed to the piece of furniture. By this, it is also avoided that any fixation means have to be provided at the piece of furniture.

Above, the piece of furniture according to the invention and the storage module according to the invention have been described on the basis of the example of a high table. The invention, however, is not limited to high tables. Rather, different pieces of furniture, as bookshelves, bed tables, roller containers, desks, or other pieces of furniture, which comprise a shelf space for the deposition of electrical devices, for example, kitchen worktops, may be configured according to the invention and equipped with a storage module according to the invention.

Further, a storage module has been described above, which comprises connection contacts 22 corresponding to connection contacts 16 provided in the recess 15 of the piece of furniture 10. Instead of these connection contacts, plug in connections or other connection means may be provided, by means of which the storage module 20 can be connected to the electrical wires integrated in the piece of furniture.

Moreover, in FIG. 2 and FIG. 5 storage modules according to the invention are shown, which respectively comprise a certain number of storage means, e.g., accumulators 21. According to the concrete requirements to the capacity or performance of the storage module 20, more or less storage means 21 may be provided than shown in FIG. 2 or FIG. 5. Whether the accumulators 21 are connected in series and/or in parallel depends on the concrete requirements to the capacity or performance of the storage module.

In an embodiment of the invention not shown above, the storage module 20 may comprise a connection wire, by means of which the storage module can be connected to a piece of furniture 10. Hereby, the piece of furniture 10 may comprise for example a socket, which is coupled to the transmission means 40, 50 via electrical wires. Similar to the storage module shown in FIG. 5, also an ad hoc power supply may be provided, if for example, the integrated storage module fails.

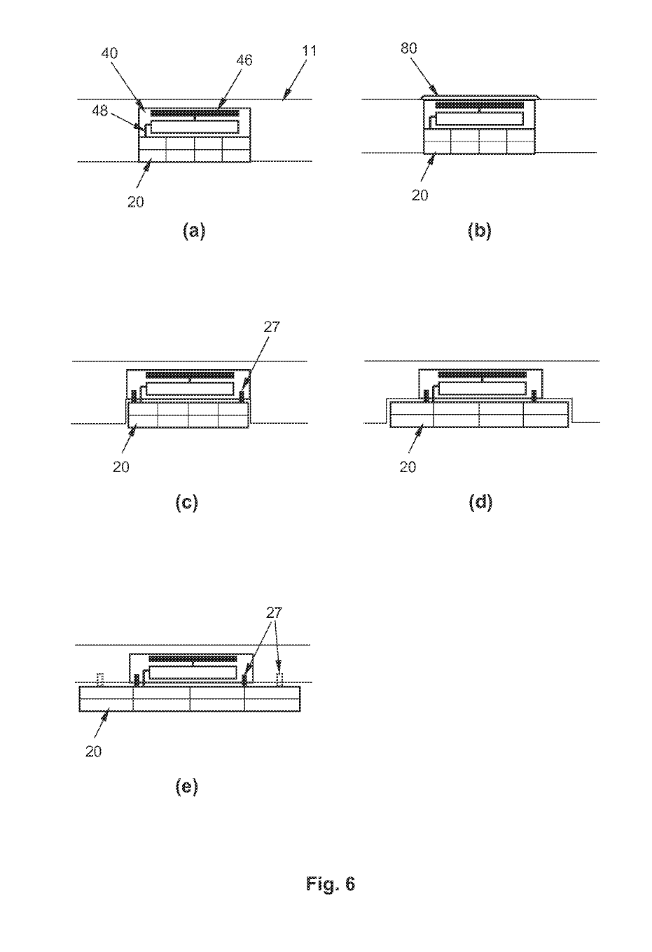

FIG. 6 shows various embodiments of an electronic component according to the invention, which can be integrated in a piece of furniture or in a furniture panel 11 of a piece of furniture.

The electronic component comprises a transmission means 14, by means of which an electronic device, for example a smart phone, can be charged. The transmission means, in the embodiment shown in FIG. 6, comprises a transmitter of an inductive charging means. Instead of a transmitter, a terminal for the charging wire, as a USB interface, may be provided, to which the electronic device may be connected via the charging wire.

Further, the electronic component comprises storage module for storing electrical energy and for supplying the stored electrical energy to the transmission means 40.

With respect to the embodiment of the electronic component shown in figure (a), the transmitter 40 and the storage module 20 are configured as a unit, wherein the transmitter 40 is coupled to the storage module 20 electrically via electrical connections 48. The unit consisting of the transmitter 40 and the storage module 20 may be arranged within a housing, wherein at the top side of the housing, the primary coil or the transmitter coil 46 of the transmitter 40 is arranged. The area of the housing facing the transmitter coil 46 comprises a material, which allows or ensures an inductive energy transmission to an electrical device deposited on the furniture panel 11. The electronic components of the transmitter and the storage module 20 are arranged below the transmitter coil 46.

The electronic component according to the invention may be arranged within the recess provided at the lower side of the furniture panel 11. Preferably, the electrical component can be arranged within the recess releasably such that the latter can be replaced by another electronic component according to the invention, for example, in a case, where the storage module of the electronic component is to be removed from the recess for charging.

In the figure (b), an alternative embodiment of an electronic component according to the invention is shown. In contrast to the electronic component shown in figure (a), this one is arranged within the through hole of the furniture panel 11, wherein also here, the electronic component preferably is arranged releasably within the opening or within the through hole. At the upper side, the housing comprises a cover plate 80, which preferably protrudes from the housing at the edge such that the protruding portion of the cover plate 80 rests on the furniture panel 11 during insertion of the electronic component into the through hole. The electronic component, thus, may be inserted into the through hole from above. In the area of the transmitter coil 46, the cover plate 80 comprises a material enabling an inductive energy transmission.

According to an embodiment of the electronic component of the invention, the cover plate 80 may be arranged at the electronic component or at the housing of the electronic component releasably. Thereby, an electronic component according to the invention may be provided with different cover plates 80, for example with cover plates having different diameters, and order to allow the electronic component according to the invention to be integrated into furniture panels having differently sized through holes.

According to the embodiment of an electronic component according to the invention shown in figure (c), the storage module 20 may be arranged at the transmitter 40 releasably. This has the advantage that the storage module 20 can be removed from the transmitter 40 in order to subject it to a charging procedure. According to this embodiment, the transmitter 40 may be arranged fixedly in a recess provided at the lower side of the furniture panel 11. Fixation means 27 may be provided at the transmitter 40 or at the storage module 20 in order to fix the storage module 20 releasably at the transmitter. Further, a plug in contact is provided at the storage module 20 or at the transmitter 40, via which the storage module 20 may be coupled to the transmitter 40 electrically.

The embodiment of an electronic component according to the invention shown in figure (c) may also be arranged of the within a through hole, as shown in figure (b), wherein it is advantageous, if a cover plate 80 is also arranged at the housing of the electronic component or at the housing of the transmitter 40.

In figure (d), an alternative embodiment of the electronic component shown in figure (c) is shown. The transmitter 40 of the inductive charging means, here, is arranged within a recess provided at the lower side of the furniture panel 11. The storage module 20 has a larger diameter than the transmitter 40, or protrudes laterally beyond the transmitter 40. In order to be able to substantially integrate the storage module 20 into the furniture panel 11, a recess is provided at the lower side of the furniture panel 11, in which also the storage module 20 may be arranged.

Also according to the embodiment of the electronic component according to the invention shown in figure (d), the storage module 20 can be arranged via fixation means 27 releasably at the transmitter 40.

According to the embodiment of an electronic component according to the invention shown in figure (e), the transmitter 40 is arranged at the lower side of the furniture panel 11 within a recess. Via fixation means 27, the storage module 20 may be fixed to the lower side of the furniture panel 11 either at the transmitter 40 and/or at the lower side of the furniture panel 11 releasably. Also here, an electrical connection 48 may be provided, by means of which the storage module 20 may be coupled to the transmitter 40 electrically. The embodiment of an electronic component according to the invention shown in figure (e) has the advantage that these may be integrated into furniture panels having a thickness which is too low for arranging the entire electrical component within a recess of the furniture panel.

By means of the releasable arrangement of the storage module 20 at the transmitter 40, the storage module 20 can be removed from the piece of furniture of from the furniture panel independently of the transmitter 40, and maybe subjected to, for example, to a charging procedure.

Also with respect to the embodiments of the electronic components according to the invention shown in figures (d) and (e), these may be arranged within a through hole of the furniture panel, wherein a cover plate 80 preferably is arranged at the top side of the housing of the electronic component, as shown with respect to figure (b).

The embodiments of an electronic component having a storage module 20 and the transmitter 40 shown in FIG. 6 have the advantage that no electrical wires have to be provided or integrated into the piece of furniture or into the furniture panel, via which the transmitter can be connected or is connectable to the storage module 20 electrically. Only a recess or a through hole has to be provided, in which the electronic component can be arranged.

### REFERENCE NUMERALS

10 piece of furniture, e.g., high table, desk, bookshelf, or the like
11 furniture panel of a piece of furniture
15 recess at the piece of furniture 10 for receiving the storage module 20
16 connection contacts in the recess 15 (corresponding to the connection contacts 22 of the storage module 20)
20 storage module for storing electrical energy
21 storage means (e.g., accumulator or battery)
22 connection contacts of the storage module 20
23 fixing means or locking means (lock)
24 housing of the storage module 20
25 cover plate of the storage module 20 (preferably adapted to the surface of the piece of furniture 10)
26 primary coil (transmitter coil) of the storage module 20
27 fixing means for fixing the charging module 20 at the transmission means 40
30 electrical wires
40 transmission means—transmitter of an inductive charging means
45 secondary coil (receiver coil) of the transmitter 40
46 primary coil (transmitter coil) of the transmitter 40
47 shielding between secondary coil 45 and primary coil 46
48 electrical connection between transmission means 40 and storage module 20
50 transmission means—terminal for charging cable (e.g., USB, micro-USB, or socket)
60 connection means (e.g., socket)
70 indication means (e.g., LED)
80 cover plate of the transmission means 40shows a system comprising a client system C and a server system S, which are coupled or can be coupled to each other via a communications network 30, for example, the internet.

What is claimed is:

1. A piece of furniture, wherein a storage module for storing electrical energy and for supplying the stored electrical energy to an electrical device which can be arranged at the piece of furniture can be arranged at or in the piece of furniture.

2. The piece of furniture of claim 1, wherein the piece of furniture comprises a recess or a through hole, in which the storage module is arranged preferably releasably.

3. The piece of furniture of claim 1, wherein transmission means are arranged or can be arranged at or in the piece of furniture, which are adapted to transmit the energy supplied from the storage module to the electrical device arranged at the piece of furniture and wherein the transmission means comprise a transmitter of an inductive charging system or a terminal for a charging cable of the electronic device.

4. The piece of furniture of claim 3, wherein electrical wires are arranged in the piece of furniture, which connect the storage module to the transmission means electrically.

5. The piece of furniture of claim 2, wherein connection contacts are provided within the recess or within the through hole corresponding to connection contacts of the storage module, and cooperate with these, if the storage module is arranged within the recess wherein the connection contacts arranged within the recess or within the through hole are coupled to the electrical wires.

6. The piece of furniture of claim 2, wherein the recess or the through hole can be covered or can be locked by a cover plate, wherein the cover plate is a part of the storage module, wherein the cover plate comprises fixing means, by means of which the cover plate is fixable at the piece of furniture, in particular, at or in the recess or at or in the through hole, and wherein the fixing means comprise a locking means, in particular, a lock.

7. The piece of furniture of claim 1, wherein connection means for connecting the piece of furniture to an external power supply are provided at the piece of furniture and wherein the connection means are connected to the storage module electrically, if the storage module is arranged within the recess or within the through hole.

8. A storage module for a piece of furniture, in particular, for the piece of furniture of claim 1, wherein the storage module is adapted for storing electrical energy and for supplying the stored electrical energy to a terminal, which is arranged at or on the piece of furniture, characterized in that the storage module can be integrated in the piece of furniture, and can be coupled to transmission means arranged in or at the piece of furniture, which are adapted to transmit the electrical energy supplied from the storage module to the electrical device arranged at or on the piece of furniture.

9. The storage module of claim 8, wherein the storage module can be coupled to the transmission means via electrical wires arranged within the piece of furniture.

10. The storage module of claim 8, wherein the storage module can be coupled to the transmission means on an inductive basis electrically, wherein the storage module comprises at least a transmitter coil, via which the electrical energy of the storage module is transmitted to the transmission means.

11. The storage module of claim 8, wherein a cover plate is arranged at the storage module, wherein the cover plate with respect to its dimensions is adapted to cover the recess or a side of the through hole upon arranging the storage module within a recess or within a through hole of the piece of furniture, wherein the cover plate comprises fixing means, by means of which the cover plate can be fixed to the piece of furniture, in particular, at or in the recess or at a side of the through hole and wherein the fixing means comprise locking means, in particular, a lock.

12. The storage module of claim 8, wherein the storage module can be connected to an external charging means in order to charge the storage module, or wherein the storage module comprises an internal charging means, which can be connected to an external power supply in order to charge the storage module.

13. The storage module of claim 8, wherein the storage module comprises connection contacts, which correspond to connection contacts arranged in the recess or in the through hole of the piece of furniture, and which cooperate with these, if the storage module is arranged within the recess or within the through hole, wherein the connection contacts preferably are coupled to the transmission means arranged in or at the piece of furniture electrically.

14. The storage module of claim 8, wherein the latter comprises an indication means being adapted to indicate a charging state of the storage module, wherein the indication means is arranged at the cover plate, and preferably comprises a light emitting diode.

15. The storage module of claim 8, wherein the latter comprises a number of storage means connected in series or in parallel, in particular, accumulators, which preferably are arranged within a housing.

16. The storage module of claim 8, wherein ventilation holes and/or ventilation slots are provided within the cover plate, in particular, in order to dissipate heat energy of the storage module arranged within the recess.

17. A furniture system, comprising:
a piece of furniture wherein a storage module for storing electrical energy and for supplying the stored electrical energy to an electrical device which can be arranged at the piece of furniture can be arranged at or in the piece of furniture; and
at least one storage module of claim 8, wherein the at least one storage module can be integrated into the piece of furniture.

18. The furniture system of claim 17, wherein the storage module or the electronic component are arranged within the recess or within a through hole of the piece of furniture releasably.

19. The furniture system of claim 18, wherein the storage module is integrated into the piece of furniture non-releasably, wherein the piece of furniture comprises connection means in order to connect the storage module for charging to an external power supply.
